(19) United States
(12) Patent Application Publication
(10) Pub. No.: US 2026/0225357 A1
(43) Pub. Date: Aug. 6, 2026

(54) A METHOD FOR MANUFACTURING A PAPER OR PAPERBOARD BASED PACKAGING LAMINATE

(71) Applicant: Stora Enso OYJ, Helsinki (FI)

(72) Inventors: Otto Nylén, Helsinki (FI); Anni Karppinen, Espoo (FI); Kaj Backfolk, Lappeenranta (FI)

(73) Assignee: Stora Enso OYJ, Helsinki (FI)

(21) Appl. No.: 19/154,028

(22) PCT Filed: Dec. 19, 2023
(86) PCT No.: PCT/IB2023/062944

§ 371 Date: Aug. 6, 2025

(30) Foreign Application Priority Data
Feb. 7, 2023 (SE) 2330067-6

(51) Int. Cl. B32B 29/00; B32B 7/12; B32B 27/10; B32B 27/30

(52) U.S. Cl. CPC B32B 29/005; B32B 7/12; B32B 27/10; B32B 27/306; B32B 2307/31; B32B 2307/54; B32B 2307/582; B32B 2307/718; B32B 2307/7244; B32B 2307/7246; B32B 2439/70

(57) ABSTRACT

The present invention relates to a method for manufacturing a paper or paperboard based packaging laminate, said method comprising: a) providing a paper or paperboard substrate, b) providing a microfibrillated cellulose (MFC) film comprising at least 50 wt % of MFC based on the dry weight of the MFC film, and c) laminating a surface of the paper or paperboard substrate to a surface of the MFC film by a melt adhesive process using a melt adhesive comprising at least 50 wt % of a water soluble thermoplastic polymer based on the dry weight of the melt adhesive, wherein the melt adhesive is applied to the surface of the paper or paperboard substrate and/or to the surface of the MFC film in a low solvent or solvent free form.

### TECHNICAL FIELD

The present disclosure relates to paper or paperboard based packaging laminates comprising a microfibrillated cellulose (MFC) film as a barrier layer, and to methods for manufacturing such laminates.

### BACKGROUND

Coating of paper and paperboard with plastics is often employed to combine the mechanical properties of the paper or paperboard with the barrier and sealing properties of a plastic film or layer. Paper or paperboard provided with even a relatively small amount of a suitable plastic material can provide the properties needed to make the paper or paperboard suitable for many demanding applications, for example as liquid or food packaging. In liquid or food packaging board, polyolefin coatings are frequently used as liquid barrier layers, heat sealing layers and adhesives. However, the recycling of such polymer coated board is difficult since it is difficult to separate the polymers from the fibers.

Also, in many cases the water vapor barrier properties of the polymer coated paper or paperboard are still insufficient unless the coating layers are thick or combinations of different polymer coating layers are used. Therefore, in order to ensure high water vapor barrier properties, the polymer coated paper or paperboard is often combined with one or more layers of aluminum foil. The aluminum foil is typically bonded to the laminate using one or more polymeric tie-layers. However, the addition of polymer and aluminum foil add significant costs and the combination of polymeric layers and aluminum foils makes recycling of the materials more difficult. Also, due to its high carbon footprint there is a wish to replace aluminum foils in paper and paperboard based packaging materials.

Aseptic packaging for long shelf-life products such as milk and juices are usually made from liquid or food packaging board comprising a multilayer paperboard based substrate, an outermost heat-sealable polyolefin (e.g. polyethylene, PE) layer and innermost layers of polyolefin and aluminum. The aluminum foil layer, which is needed to provide water vapor and oxygen barrier properties, is usually incorporated between tie-layers of polyethylene to provide the following structure: PE/paperboard/PE/aluminum foil/PE.

In the prior art, attempts have been made to replace the aluminum foil with more environmentally friendly and/or easier to recycle solutions, but so far with no real success. For example, microfibrillated cellulose (MFC) films and coatings have been developed, in which cellulosic fibrils provided by fibrillation of cellulose fibers have been dispersed e.g. in water and thereafter re-organized and rebonded together to form a dense film or coating with excellent gas barrier properties. The MFC films are typically laminated to the paper or paperboard in the same manner as aluminum foils, using PE-based tie layers which limit the recyclability of the laminate. As an alternative to the PE-based tie layers, conventional water based adhesives e.g. containing water soluble PVOH have been considered. Unfortunately, since the MFC films are sensitive to moisture, the conventional water based adhesive composition may lead to dimensional stability problems, such as cockling, wrinkles, and shrinkage in the MFC film and in the resulting paper or paperboard based packaging laminate.

Thus, there remains a need for improved solutions to replace the combination of plastic films and aluminum foils in paper and paperboard based packaging materials, while maintaining acceptable liquid and oxygen barrier properties. At the same time, there is a need to replace the combination of plastic films and aluminum foils with alternatives that facilitate re-pulping and recycling of the used packaging materials.

### DESCRIPTION OF THE INVENTION

It is an object of the present disclosure to provide an alternative to the combinations of plastic films and aluminum foils commonly used as barrier films for providing water vapor barrier properties in packaging materials, such as liquid or food packaging board.

It is a further object of the present disclosure to provide a paper or paperboard based packaging laminate, such as a liquid or food packaging board, which provides good water vapor barrier properties even at higher relative humidity and temperature.

It is a further object of the present disclosure to provide a paper or paperboard based packaging laminate, which has a water vapor transmission rate (WTR), measured according to the standard ASTM F1249-20 at 50% relative humidity and 23° C., of less than 30 cc/m²/24 h, and preferably less than 5 cc/m²/24 h.

It is a further object of the present disclosure to provide a paper or paperboard based packaging laminate, such as a liquid or food packaging board, comprising a water vapor barrier layer which facilitates re-pulping of the board as compared to packaging laminates using conventional combinations of plastic films and aluminum foils.

It is a further object of the present disclosure to provide a paper or paperboard based packaging laminate having a reject rate according to PTS-RH 021:2012 of less than 20%, preferably less than 15%.

The above-mentioned objects, as well as other objects as will be realized by the skilled person in the light of the present disclosure, are achieved by the various aspects of the present disclosure.

According to a first aspect illustrated herein, there is provided a method for manufacturing a paper or paperboard based packaging laminate, said method comprising:
a) providing a paper or paperboard substrate,
b) providing a microfibrillated cellulose (MFC) film comprising at least 50 wt % of MFC based on the dry weight of the MFC film, and
c) laminating a surface of the paper or paperboard substrate to a surface of the MFC film by a melt adhesive process using a melt adhesive comprising at least 50 wt % of a water soluble thermoplastic polymer based on the dry weight of the melt adhesive, wherein the melt adhesive is applied to the surface of the paper or paperboard substrate and/or to the surface of the MFC film in a low solvent or solvent free form.

Paper generally refers to a material manufactured in thin sheets or webs from the pulp of wood or other fibrous substances comprising cellulose fibers, used for writing, drawing, or printing on, or as packaging material.

Paperboard generally refers to strong and/or stiff, thick paper or cardboard comprising cellulose fibers used for boxes and other types of packaging. Paperboard can either be bleached or unbleached, coated or uncoated, and produced in a variety of thicknesses, depending on the end use requirements. Paperboard may be a single ply material, or a multiply material comprised of two or more plies.

A paper or paperboard based packaging laminate is a packaging material formed mainly from a paper or paperboard substrate. The paper or paperboard substrate can be made from pulp, including pulp from virgin fiber, e.g. mechanical, chemical and/or thermomechanical pulps. It can also include broke or recycled paper. In addition to the paper or paperboard substrate, the paper or paperboard based packaging laminate may comprise additional layers or coatings designed to improve the performance and/or appearance of the packaging laminate.

The paper or paperboard based packaging laminate typically has a first outermost surface intended to serve as the outside surface, or print side, and a second outermost surface intended to serve as the inside surface of a packaging container.

The paper or paperboard based packaging laminate obtained by the inventive method can provide excellent water vapor barrier properties and, when further provided with outermost polymeric sealing layers, also excellent liquid barrier properties.

The paper or paperboard substrate used in the inventive method is preferably a relatively thick paper or paperboard, having a grammage of at least 80 g/m² and a density below 800 kg/m³.

The paper or paperboard substrate may also be heavier. In some embodiments, the paper or paperboard substrate has a grammage of at least 100 g/m². In some embodiments, the paper or paperboard substrate has a grammage of at least 150 g/m², 200 g/m², 250 g/m², 300 g/m², 350 g/m², or 400 g/m². The grammage of the paper or paperboard substrate is preferably below 1000 g/m², 800 g/m², or 600 g/m². Unless otherwise stated, the grammage is determined according to the standard ISO 536.

In some embodiments, the paper or paperboard substrate has a density below 700 kg/m³, preferably below 600 kg/m³. Unless otherwise stated, the density is determined according to the standard ISO 534.

The paper or paperboard substrate may be a single ply paperboard or a multiply paperboard. In some embodiments, the paperboard substrate is a multiply paperboard. In some embodiments the paperboard substrate is a multiply paperboard comprised of two or more plies. In some embodiments the paperboard substrate is a multiply paperboard comprised of three or more plies. In some embodiments the paperboard substrate is a multiply paperboard comprised of a lower density mid-ply sandwiched between two higher density outer plies. The lower density mid-ply may typically have a density below 750 kg/m³, preferably below 700, below 650, below 600, below 550, below 500, below 450, below 400 or below 350 kg/m³. The higher density outer plies typically have a density at least 100 kg/m³ higher than the mid-ply, preferably at least 200 kg/m³ higher than the mid-ply.

In some embodiments, the paper or paperboard substrate is a foam formed paperboard. In some embodiments wherein the paperboard substrate is a multiply paperboard, at least one of the plies, preferably a mid-ply, is foam formed.

The structure of the inventive paper or paperboard based packaging laminate enables the use of a larger amount of recycled fibers, such as fibers obtained from used beverage cartons, in the paper or paperboard substrate since the MFC film hinders the migration of mineral oil based compounds. Thus, in some embodiments, the paper or paperboard substrate comprises at least 5 wt % recycled fibers, preferably at least 10 wt % recycled fibers.

In some embodiments, the paper or paperboard substrate further comprises a mineral coating layer on one or both of its main surfaces. In some embodiments, the mineral coating layer comprises 50-95 wt % of a particulate mineral, and 5-50 wt % of a binder, based on the dry weight of the mineral coating layer. In some embodiments, the particulate mineral is selected from the group consisting of kaolin, calcium carbonate, bentonite, talc, and combinations thereof, preferably kaolin or calcium carbonate, and more preferably kaolin. The binder may comprise a single binder or a combination of binders. The binder may preferably comprise a water-dispersible or water-soluble binder, or a combination thereof. In some embodiments, the water-dispersible binder comprises a latex binder. In some embodiments, the water-soluble binder comprises a starch, PVOH, a cellulose derivate such as CMC, a protein, or seaweed. An advantage of using a water-soluble binder is that the laminate will be even more easy to recycle. In some embodiments, the grammage of the mineral coating layer is in the range of 4-30 g/m², more preferably in the range of 6-14 g/m².

The paper or paperboard substrate, before the MFC film is laminated to the substrate, typically has a high water vapor transmission rate (WVTR) value, i.e. poor water vapor transmission resistance. In some embodiments, the paper or paperboard substrate has a water vapor transmission rate (WVTR), measured according to the standard ASTM F1249-20 at 50% relative humidity and 23° C., of above 100 g/m²/24 h, typically above 200 g/m²/24 h, above 300 g/m²/24 h, or above 1000 g/m²/24 h.

A microfibrillated cellulose (MFC) film comprising at least 50 wt % of MFC based on the dry weight of the MFC film is provided as a barrier for oxygen and water vapor in the paper or paperboard based packaging laminate. In some embodiments, the MFC film comprises at least 70 wt %, preferably at least 75 wt %, and more preferably at least 80 wt %, of MFC based on the dry weight of the MFC film.

Microfibrillated cellulose (MFC) shall in the context of the patent application mean a cellulose particle, fiber or fibril having a width or diameter of from 20 nm to 1000 nm. Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC is produced from wood cellulose fibers, both from hardwood and softwood fibers. It can also be made from microbial sources, agricultural fibers such as wheat straw pulp, bamboo, bagasse, or other non-wood fiber sources. It is preferably made from pulp including pulp from virgin fiber, e.g. mechanical, chemical and/or thermomechanical pulps. It can also be made from broke or recycled paper.

In some embodiments, the MFC has a Schopper Riegler (SR) value in the range of 80-100, preferably in the range of 85-100, more preferably in the range of 90-100, according to standard ISO 5267-1.

In some embodiments, the MFC has a water retention value (WRV) value of at least 230%, preferably at least 280%, according to standard ISO 23714:2014.

In some embodiments, the MFC film further comprises 1-30 wt % of unrefined or slightly refined cellulose pulp based on the dry weight of the MFC film, wherein the unrefined or slightly refined cellulose pulp has a Schopper Riegler (SR) value in the range of 10-50, preferably in the range of 15-40, more preferably in the range of 20-30, according to standard ISO 5267-1. In some embodiments, the MFC film further comprises no unrefined or slightly refined cellulose pulp.

In some embodiments, the MFC film further comprises 1-30 wt % of a polyvinyl alcohol (PVOH) based on the dry weight of the MFC film. The PVOH may be PVOH or a derivative or analogue thereof. The PVOH may be a single type of PVOH, or it can comprise a mixture of two or more types of PVOH, differing, e.g., in degree of hydrolysis or viscosity. The PVOH may for example have a degree of hydrolysis in the range of 80-99.9 mol %, preferably in the range of 88-99.9 mol %.

In some embodiments, the MFC film further comprises 1-30 wt % of nanoclay based on the dry weight of the MFC film.

In some embodiments, the MFC film further comprises 1-30 wt % of a humectant based on the dry weight of the MFC film. In some embodiments, the humectant is selected from the group consisting of non-ionic or anionic polyols, sugar alcohols, and wood hydrolysates. In some embodiments, the humectant is selected from the group consisting of sorbitol, hemicellulose, xylan, and glucose.

In order to obtain an MFC film with low permeability for oxygen and water vapor, making it suitable as a replacement for, e.g., an aluminum foil, the MFC film is preferably formed by cast forming, also referred to as casting. The term “casting”, when utilized in MFC film-forming, is a known term designating methods wherein an MFC suspension is deposited by means of contact or non-contact deposition and levelling methods on a support, typically an endless belt, to form a wet web. Examples of such deposition and levelling methods are curtain coating/application, slot die casting, or dosing the MFC suspension by spraying or similar methods and leveling with a doctor-blade or rod. The deposited suspension is then dewatered and/or dried to obtain the MFC film. The dewatering is preferably restrained dewatering and drying, whereby the film is kept under tension in one or two directions. Thus, in some embodiments, the MFC film is a cast MFC film.

In some embodiments, the grammage of the MFC film is in the range of 10-120 g/m², preferably in the range of 15-80 g/m², more preferably in the range of 20-40 g/m². Unless otherwise stated, the grammage is determined according to the standard ISO 536.

In some embodiments, the MFC film has a thickness in the range of 7-170 μm, preferably in the range of 10-114 μm, more preferably in the range of 13-57 μm.

In some embodiments, the MFC film has a density in the range of 700-1500 kg/m³, preferably 800-1500 kg/m³, most preferably 900-1500 kg/m³. Unless otherwise stated, the density is determined according to the standard ISO 534.

In some embodiments, the MFC film has a tear index (geometric mean) below 4 mN·m²/g, preferably below 3.5 mN·m²/g, and more preferably below 3 mN·m²/g, as determined according to the standard ISO 1974.

In some embodiments, the MFC film has a wet tensile strength retention below 70%, preferably below 50%, and more preferably below 30%, such as in the range of 0-30% or 1-25%, according to standard ISO 3781:2011. The wet tensile strength retention is calculated as wet strength*100/dry strength. The sample for the wet strength test is soaked for 30 minutes at 40° C. in distilled water.

In some embodiments, the MFC film has an oxygen transmission rate (OTR), measured according to the standard ASTM F1927-20 at 50% relative humidity and 23° C., of less than 30 cc/m²/24 h, preferably less than 20 cc/m²/24 h, more preferably less than 10 cc/m²/24 h, and most preferably less than 5 cc/m²/24 h.

In some embodiments, the MFC film has a water vapor transmission rate (WVTR), measured according to the standard ASTM F1249-20 at 50% relative humidity and 23° C., of less than 30 g/m²/24 h, preferably less than 20 g/m²/24 h, more preferably less than 10 g/m²/24 h, and most preferably less than 5 g/m²/24 h.

To a surface of the provided paper or paperboard substrate, a surface of the provided MFC film is laminated by a melt adhesive process using a melt adhesive comprising at least 50 wt % of a water soluble thermoplastic polymer based on the dry weight of the melt adhesive, wherein the melt adhesive is applied to the surface of the paper or paperboard substrate and/or to the surface of the MFC film in a low solvent or solvent free form. Melt adhesives, (also known as hot-melt adhesives or hot glues) are generally solid formulations based on thermoplastic polymers. Typically, no water or solvents are involved. Melt adhesives are in a solid state at room temperature and are activated upon heating above their melting point. Once melted, the melt adhesive can then be applied onto a substrate in its melted state. The melted adhesive wets the substrate, penetrating the surface and any cavities, and then it sets, ensuring cohesion. This setting process is typically very fast.

Lamination by a melt adhesive process comprises applying a melt adhesive to a surface of the paper or paperboard substrate and/or to a surface of the MFC film to be laminated, either in melted form or in solid form and subsequently melted, contacting the surfaces to be laminated, and allowing the melted melt adhesive to set, so as to form a laminate of the paper or paperboard substrate and the MFC film, bound together by the melt adhesive.

According to the present disclosure, the melt adhesive is applied in a low solvent or solvent free form. The term “low solvent or solvent free form” is used herein to denote that the melt adhesive is not applied to the surface of the paper or paperboard substrate and/or to the surface of the MFC film as a solution or dispersion in water or other liquid solvent. The term “low solvent or solvent free form” as used herein should be interpreted as a form comprising less than 10 wt %, preferably less than 8 wt %, less than 6 wt %, less than 4 wt %, or less than 2 wt %, of a liquid solvent, based on the dry weight of the melt adhesive. In some preferred embodiments, the melt adhesive is applied to the surface of the paper or paperboard substrate and/or to the surface of the MFC film in a form comprising less than 2 wt %, of a liquid solvent, based on the dry weight of the melt adhesive. In some preferred embodiments, the melt adhesive is applied to the surface of the paper or paperboard substrate and/or to the surface of the MFC film in a form comprising no liquid solvent.

Applying the melt adhesive in a low solvent or solvent free form is preferred since the MFC film is typically sensitive to moisture. Using a conventional water based adhesive composition on the MFC film may lead to dimensional stability problems, cockling, wrinkles, and shrinkage in the MFC film and in the resulting paper or paperboard based packaging laminate.

The low solvent or solvent free form of the melt adhesive is preferably a melted form or solid form.

The melt adhesive in melted form may preferably be applied to the surface of the paper or paperboard substrate and/or to the surface of the MFC film by extrusion coating. The paper or paperboard substrate can then be laminated to the MFC film using the applied melt adhesive. The lamination may be performed directly in connection with the extrusion coating when the melt adhesive is still in melted form. This process is referred to as extrusion coating lamination. Thus, in some embodiments, the melt adhesive process is extrusion coating lamination. Alternatively, the applied melt adhesive can be allowed to set and then melted again during the lamination.

The melt adhesive in solid form may for example be applied to the surface of the paper or paperboard substrate and/or to the surface of the MFC film in the form of a solid melt adhesive film or solid particles of the melt adhesive. The melt adhesive applied in solid form is then melted on the surface of the paper or paperboard substrate and/or the surface of the MFC film during the lamination.

The melt adhesive is applied on the paper or paperboard substrate or on the MFC film, or both. In some embodiments, the melt adhesive is applied to the MFC film. In some embodiments, the melt adhesive is applied only to the MFC film.

The melt adhesive may be applied on the paper or paperboard substrate or on the MFC film as a single layer and/or as two or more layers, e.g. by coextrusion. If the melt adhesive is applied as two or more layers, the grammage and composition of the melt adhesive in the two or more layers may be the same or different.

The MFC film in contact with the paper or paperboard substrate via the melt adhesive may be subjected to various treatments for improving the adhesion between the MFC film and the paper or paperboard substrate. In some embodiments, the MFC film in contact with the paper or paperboard substrate via the melt adhesive is subjected to pressure, heat, and/or radiation to improve adhesion between the MFC film and the paper or paperboard substrate.

The temperature may vary depending on contact time and lamination pressure but should generally be in the range of 40-250° C., and preferably in the range of 60-150° C. The lamination pressure should be high enough to obtain good adhesion, but not so high that the bulk of paper or paperboard substrate is destroyed. In some embodiments the lamination pressure is in the range of 0.5-100 kg/cm, preferably in the range of 1-50 kg/cm. Pressure and heating may for example be provided in a heated nip or an extended nip.

A melt adhesive comprises one or more thermoplastic polymers. The melt adhesive may consist of the one or more thermoplastic polymers, or it may also further comprise other additives for facilitating the coating process or improving the properties of the melt adhesive.

The melt adhesive in the present disclosure comprises at least 50 wt % of a water soluble thermoplastic polymer based on the dry weight of the melt adhesive. In some embodiments, the melt adhesive comprises at least 70 wt %, preferably at least 75 wt %, at least 80 wt %, at least 85 wt %, at least 90 wt %, or at least 95 wt %, of a water soluble thermoplastic polymer based on the dry weight of the melt adhesive.

Having a melt adhesive comprising at least 50 wt % of a water soluble thermoplastic polymer facilitates separation of the MFC film, the paper or paperboard substrate, and optional additional plastic layers during repulping.

In some embodiments, the water soluble thermoplastic polymer is selected from the group consisting of polyvinyl alcohols (PVOH), water soluble thermoplastic modified polysaccharides, and water soluble thermoplastic acrylic copolymers.

In some embodiments, the water soluble thermoplastic polymer is selected from the group consisting of polyvinyl alcohols (PVOH), hydroxypropylcellulose (HPC), hydroxypropylmethylcellulose (HPMC), hydroxypropylmethylcellulose acetate succinate (HPMCAS), and methacrylic acid-methyl methacrylate copolymers, and combinations thereof.

In preferred embodiments, the water soluble thermoplastic polymer is a PVOH. The PVOH may be PVOH or a derivative or analogue thereof. The PVOH may for example be modified with silanol, carboxyl, ethylene groups to provide better adhesion to the MFC film. Thus, in some embodiments, the water soluble thermoplastic polymer is a PVOH, optionally modified with silanol, carboxyl, or ethylene groups.

The PVOH may be a single type of PVOH, or it can comprise a mixture of two or more types of PVOH, differing, e.g., in degree of hydrolysis or viscosity. The PVOH may for example have a degree of hydrolysis in the range of 50-99.9 mol %, preferably in the range of 80-99.9 mol %, and more preferably in the range of 88-99.9 mol %. In some embodiments, the PVOH has an average molecular weight Mw in the range of 15 000-150 000 g/mol.

In some embodiments, the water soluble thermoplastic polymer has a density in the range of 1.1-1.6 g/cm³. Unless otherwise stated, the polymer density is determined according to ISO 1183-1: 2019.

In some embodiments, the water soluble thermoplastic polymer has a melting point in the range of 100-320° C., preferably in the range of 120-240° C., and more preferably in the range of 140-220° C. Unless otherwise stated, the melting point is determined according to ISO 11357-3: 2018.

In some embodiments, the water soluble thermoplastic polymer has a glass transition temperature (T_{g}) below 80° C., preferably below 60° C., such as in the range of 20-65° C.

In some embodiments, the melt adhesive has a melting point in the range of 100-320° C., preferably in the range of 120-240° C., and more preferably in the range of 140-220° C.

The water soluble thermoplastic polymer of the melt adhesive is at least partially soluble in cold water or in hot water, e.g. at a temperature below 100° C. or even above 100° C., for a given period of time. In some embodiments, the water soluble thermoplastic polymer of the melt adhesive is fully soluble in cold water or in hot water, e.g. at a temperature below 100° C. or even above 100° C., for a given period of time.

The solubility of the water soluble thermoplastic polymer of the melt adhesive allows for the melt adhesive to dissolve, to fully or partially disintegrate, or to become substantially weakened, when subjected to water such as during repulping.

In some embodiments, the water soluble thermoplastic polymer has a solubility in distilled water of at least 60%, preferably at least 70% and more preferably at least 80% after 30 minutes at 40° C. The solubility is determined by preparing a thin film, having a grammage of about 20 g/m² and adding a piece of the thin film to distilled water in an amount calculated to achieve a concentration of 0.1 wt %. Dissolution is achieved under gentle stirring and UV absorbance with a fully dissolved sample as reference is used to determine the degree of dissolution after a predetermined dissolution time.

In some embodiments, the melt adhesive further comprises up to 50 wt % of a microfibrillated cellulose (MFC), a thermoplastic starch or a thermoplastic cellulose, based on the dry weight of the melt adhesive.

In some embodiments, the melt adhesive further comprises up to a total of 30 wt % of other water soluble or non-soluble additives, based on the dry weight of the melt adhesive.

In some embodiments, the melt adhesive comprises a plasticizer added to the melt adhesive to increase processability of the melt adhesive by extrusion coating and to improve the elasticity of the resulting melt adhesive layer and make it less brittle. In some embodiments, the melt adhesive comprises up to 30 wt % of a plasticizer, based on the dry weight of the melt adhesive.

The plasticizer is preferably a water soluble plasticizer. In some embodiments, the plasticizer is an organic compound containing multiple hydroxyl groups, such as a diol, a triol or other polyol or sugar alcohol. In some embodiments, the plasticizer is selected from the group consisting of glycerol, xylitol, sorbitol, maltitol, ethylene glycol, propylene glycol, butanediol, pentaerythritol, trimethylolpropane, polyethylene glycol, polypropylene glycol, xylose, dextrins, and combinations thereof. In some embodiments, the plasticizer is a sugar alcohol. In some embodiments, the plasticizer is sorbitol. In some embodiments, the melt adhesive comprises 1-30 wt %, preferably in the range of 1-20 wt %, and more preferably in the range of 1-15 wt %, of the plasticizer, based on the dry weight of the melt adhesive.

Non-soluble additives may for example include a non-soluble filler, such as nanoclay.

The total amount of the other water soluble or non-soluble additives should preferably not exceed 30 wt %, based on the dry weight of the melt adhesive, as the adhesiveness of the melt adhesive may be impaired.

In some embodiments, the grammage of the melt adhesive is in the range of 2-30 g/m², preferably in the range of 3-25 g/m², more preferably in the range of 4-20 g/m², and most preferably in the range of 10-20 g/m².

In some embodiments, a film formed of the melt adhesive has a wet tensile strength retention below 20%, preferably below 10%, and more preferably below 5%, such as in the range of 0-10% or 0-5%, according to standard ISO 3781:2011. The wet tensile strength retention is calculated as wet strength*100/dry strength. The sample for the wet strength test is soaked for 30 minutes at 40° C. in distilled water.

In some embodiments, the melt adhesive is in the form of a foam. In some embodiments the melt adhesive in the form of a foam has a density in the range of 50-900 kg/m³, preferably in the range of 100-800 kg/m³, and more preferably in the range of 150-750 kg/m^{3.}

The paper or paperboard based packaging laminate may further be provided with polymeric sealing layer(s) on one side or on both sides thereof. The polymeric sealing layer(s) preferably serve as the outermost layers of the packaging laminate. The polymeric sealing layer(s) preferably provide liquid barrier properties and mechanical protection for the paper or paperboard based packaging laminate surface. At least one of the polymeric sealing layer(s) is preferably also heat-sealable.

Thus, in some embodiments, the method further comprises the step:
d) applying a first polymeric sealing layer to the MFC side of the laminate.

In some embodiments, the method further comprises the step:
e) applying a second polymeric sealing layer to the paper or paperboard substrate side of the laminate.

The polymeric sealing layer(s) may of course interfere with repulpability but may still be required or desired in some applications. The polymeric sealing layer(s) may for example be applied by extrusion coating, film lamination or dispersion coating.

The polymeric sealing layer(s) may comprise any of the thermoplastic polymers commonly used in protective and/or heat-sealable layers in paper or paperboard based packaging laminates in general or polymers used in liquid or food packaging board in particular. Examples include polyethylene (PE), polyethylene terephthalate (PET), polyethylene furanoate (PEF), polypropylene (PP), polyhydroxyalkanoates (PHA), polylactic acid (PLA), polyglycolic acid (PGA), starch and cellulose.

In some embodiments, the first and/or second polymeric sealing layer comprises a polyolefin, preferably a polyethylene (PE). Polyethylenes, especially low density polyethylene (LDPE) and high density polyethylene (HDPE), are the most common and versatile polymers used in liquid or food packaging board. The polymers used are preferably manufactured from renewable materials.

Thermoplastic polymers are useful since they can be conveniently processed by extrusion coating techniques to form very thin and homogenous films with good liquid barrier properties. In some embodiments, the additional polymer layer comprises polypropylene or polyethylene. In preferred embodiments, the polymeric sealing layer(s) comprise polyethylene, more preferably LDPE or HDPE.

In some embodiments, the polymeric sealing layer(s) are formed by extrusion coating of the polymer onto a surface of the paper or paperboard substrate or laminate. Extrusion coating is a process by which a molten plastic material is applied to a substrate to form a very thin, smooth and uniform layer. The coating can be formed by the extruded plastic itself, or the molten plastic can be used as an adhesive to laminate a solid plastic film onto the substrate. Common plastic resins used in extrusion coating include polyethylene (PE), polypropylene (PP), and polyethylene terephthalate (PET).

The basis weight of each of the polymeric sealing layer(s) is preferably less than 50 g/m². In order to achieve a continuous and substantially defect free film, a basis weight of the polymeric sealing layer of at least 8 g/m², preferably at least 12 g/m² is typically required. In some embodiments, the basis weight of the polymeric sealing layer is in the range of 8-50 g/m², preferably in the range of 12-50 g/m².

Some examples of possible embodiments are shown below:
polyolefin/paperboard substrate/melt adhesive/MFC film/polyolefin
paperboard substrate/melt adhesive/melt adhesive/MFC film/polyolefin
polyolefin/paperboard substrate/mineral coating/melt adhesive/MFC film/polyolefin
paperboard substrate/melt adhesive/MFC film/polyolefin
ink receiving layer/paperboard substrate/melt adhesive/MFC film/polyolefin

The obtained paper or paperboard based packaging laminate has a high resistance to oxygen and water vapor. This makes the inventive packaging laminate an interesting and viable alternative to conventional materials using aluminum foil layers.

In some embodiments, the obtained paper or paperboard based packaging laminate has an oxygen transmission rate (OTR), measured according to the standard ASTM F1927-20 at 50% relative humidity and 23° C., of less than 30 cc/m²/24 h, preferably less than 20 cc/m²/24 h, more preferably less than 10 cc/m²/24 h, and most preferably less than 5 cc/m²/24 h.

In some embodiments, the obtained paper or paperboard based packaging laminate has a water vapor transmission rate (WVTR), measured according to the standard ASTM F1249-20 at 50% relative humidity and 23° C., of less than 30 g/m²/24 h, preferably less than 20 g/m²/24 h, more preferably less than 10 g/m²/24 h, and most preferably less than 5 g/m²/24 h.

The inventive packaging laminate is an interesting and viable alternative to conventional materials using metallic or metal based layers, such as aluminum foil layers. Thus, in some embodiments the obtained paper or paperboard based packaging laminate comprises no metallic or metal based layer.

According to a second aspect illustrated herein, there is provided a method for manufacturing a container, particularly a liquid or food packaging container, said method comprising:
a) manufacturing a paperboard based packaging laminate according to the first aspect described herein; and
b) converting the paperboard based packaging laminate into a container.

The step of converting the paperboard based packaging laminate into a container may typically comprise the steps of printing, cutting, creasing, folding and sealing the packaging laminate to form a container, and optionally the step of attaching a lid, cap or other closure to the container. The container may advantageously be a container for aseptic packaging of dry or semiwet food, or liquids.

In some embodiments, the MFC film faces the inside of the container.

According to a third aspect illustrated herein, there is provided a paper or paperboard based packaging laminate comprising:
a paper or paperboard substrate, and
a microfibrillated cellulose (MFC) film comprising at least 50 wt % of MFC based on the dry weight of the MFC film,
   wherein a surface of the paper or paperboard substrate is laminated to a surface of the MFC film by a melt adhesive comprising at least 50 wt % of a water soluble thermoplastic polymer based on the dry weight of the melt adhesive.

In some embodiments, the MFC film of the paper or paperboard based packaging laminate is further defined as set out herein with reference to the first aspect.

In some embodiments, the melt adhesive of the paper or paperboard based packaging laminate is further defined as set out herein with reference to the first aspect.

In some embodiments, the paper or paperboard based packaging laminate further comprises:
a first polymeric sealing layer applied to the MFC side of the laminate.

In some embodiments, the paper or paperboard based packaging laminate further comprises:
a second polymeric sealing layer applied to the paper or paperboard substrate side of the laminate.

In some embodiments, the first and/or second polymeric sealing layer comprises a polyolefin, preferably a polyethylene (PE).

In some embodiments, the paper or paperboard based packaging laminate is further defined as set out herein with reference to the first aspect.

A paper or paperboard based packaging laminate is a packaging material formed mainly from cellulose-based materials. In the inventive paper or paperboard based packaging laminate, both the paper or paperboard substrate and the MFC film are formed mainly from cellulose-based materials. In some embodiments, the paper or paperboard based packaging laminate comprises more than 70 wt %, preferably more than 75 wt %, and more preferably more than 80 wt %, and most preferably more than 85 wt %, of cellulose-based material, based on the dry weight of the paperboard based packaging laminate.

The inventive paper or paperboard based packaging laminate can provide an alternative to conventional materials using aluminum foil layers, which can more readily be repulped and recycled. The melt adhesive of the inventive paper or paperboard based packaging laminate comprises at least 50 wt % of a water-soluble thermoplastic polymer based on dry weight. The water-soluble thermoplastic polymer arranged between and in contact with the paper or paperboard substrate and the MFC film has been found to allow for effective separation of the MFC film from the paper or paperboard substrate during repulping. In some embodiments, the paper or paperboard based packaging laminate has a total reject according to PTS-RH 021:2012 of less than 20%, and preferably less than 15%.

According to yet a further aspect illustrated herein, there is provided a container, particularly a liquid or food packaging container, obtained by a method according to the second aspect illustrated herein. The container may advantageously be a container for aseptic packaging of dry or semiwet food, or liquids.

Generally, while the products, polymers, materials, layers and processes are described in terms of “comprising” various components or steps, the products, polymers, materials, layers and processes can also “consist essentially of” or “consist of” the various components and steps.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for manufacturing a paper or paperboard based packaging laminate, said method comprising:
a) providing a paper or paperboard substrate,
b) providing a microfibrillated cellulose (MFC) film comprising at least 50 wt % of MFC based on a dry weight of the MFC film, and
c) laminating a surface of the paper or paperboard substrate to a surface of the MFC film by a melt adhesive process using a melt adhesive comprising at least 50 wt % of a water soluble thermoplastic polymer based on a dry weight of the melt adhesive,
wherein the melt adhesive is applied to the surface of the paper or paperboard substrate, or to the surface of the MFC film, or to both in a low solvent or solvent free form.

2. (canceled)

3. The method according to claim 1, wherein the MFC has a Schopper Riegler (SR) value in a range of 80-100, according to standard ISO 5267-1.

4. (canceled)

5. (canceled)

6. The method according to claim 1, wherein the MFC film further comprises 1-30 wt % of a polyvinyl alcohol (PVOH) based on the dry weight of the MFC film.

7. (canceled)

8. (canceled)

9. (canceled)

10. (canceled)

11. (canceled)

12. (canceled)

13. The method according to claim 1, wherein the MFC film has an oxygen transmission rate (OTR), measured according to standard ASTM F1927-20 at 50% relative humidity and 23° C., of less than 30 cc/m²/24 h.

14. The method according to claim 1, wherein the MFC film has a water vapor transmission rate (WVTR), measured according to standard ASTM F1249-20 at 50% relative humidity and 23° C., of less than 30 g/m²/24 h.

15. The method according to claim 1, wherein the melt adhesive comprises at least 70 wt % of a water soluble thermoplastic polymer based on the dry weight of the melt adhesive.

16. The method according to claim 1, wherein the water soluble thermoplastic polymer is selected from a group consisting of: polyvinyl alcohols (PVOH), water soluble thermoplastic modified polysaccharides, and water soluble thermoplastic acrylic copolymers.

17. The method according to claim 1, wherein the water soluble thermoplastic polymer is selected from a group consisting of: polyvinyl alcohols (PVOH), hydroxypropylcellulose (HPC), hydroxypropylmethylcellulose (HPMC), hydroxypropylmethylcellulose acetate succinate (HPMCAS), methacrylic acid-methyl methacrylate copolymers, and combinations thereof.

18. The method according to claim 1, wherein the water soluble thermoplastic polymer is a polyvinyl alcohol (PVOH).

19. The method according to claim 1, wherein the melt adhesive has a melting point in the a range of 100-320° C.

20. The method according to claim 1, wherein the melt adhesive further comprises up to 50 wt % of a microfibrillated cellulose (MFC), a thermoplastic starch, or a thermoplastic cellulose, based on the dry weight of the melt adhesive.

21. The method according to claim 1, wherein the melt adhesive further comprises up to 30 wt % of a plasticizer, based on the dry weight of the melt adhesive.

22. The method according to claim 1, wherein a grammage of the melt adhesive is in a range of 2-30 g/m².

23. (canceled)

24. The method according to claim 1, wherein the melt adhesive comprises a foam.

25. The method according to claim 1, wherein the melt adhesive process is an extrusion coating lamination.

26. The method according to claim 1, further comprising the step:
d) applying a first polymeric sealing layer to a side of the paper or paperboard based packaging laminate comprising the MFC film.

27. (canceled)

28. (canceled)

29. (canceled)

30. The method according to claim 1, wherein the paper or paperboard based packaging laminate has an oxygen transmission rate (OTR), measured according to standard ASTM F1927-20 at 50% relative humidity and 23° C., of less than 30 cc/m²/24 h.

31. The method according to claim 1, wherein the paper or paperboard based packaging laminate has a water vapor transmission rate (WVTR), measured according to standard ASTM F1249-20 at 50% relative humidity and 23° C., of less than 30 g/m²/24 h.

32. (canceled)

33. (canceled)

34. A paper or paperboard based packaging laminate comprising:
a paper or paperboard substrate, and
a microfibrillated cellulose (MFC) film comprising at least 50 wt % of MFC based on a dry weight of the MFC film,
wherein a surface of the paper or paperboard substrate is laminated to a surface of the MFC film by a melt adhesive comprising at least 50 wt % of a water soluble thermoplastic polymer based on a dry weight of the melt adhesive.

35. (canceled)

36. (canceled)

37. The paper or paperboard based packaging laminate according to claim 34, further comprising:
a first polymeric sealing layer applied to a side of the paper or paperboard based packaging laminate comprising the MFC film.

38. (canceled)

39. (canceled)

40. (canceled)

41. (canceled)

42. (canceled)
